(19) United States
(12) Patent Application Publication
(10) Pub. No.: US 2017/0311118 A1
(43) Pub. Date: Oct. 26, 2017

(54) METHOD AND SYSTEM FOR MANUFACTURING COMPENSATOR FOR TOTAL BODY IRRADIATION USING CAMERA

(71) Applicant: THE CATHOLIC UNIVERSITY OF KOREA INDUSTRY - ACADEMIC COOPERATION FOUNDATION, Seoul (KR)

(72) Inventors: TAE-SUK SUH, Seoul (KR); MIN-YOUNG LEE, Seoul (KR)

(21) Appl. No.: 15/171,073

(22) Filed: Jun. 2, 2016

(30) Foreign Application Priority Data
Apr. 22, 2016 (KR) 10-2016-0049357

(51) Int. Cl. H04W 4/00; G05B 19/4099; B33Y 30/00; B29L 31/00; B33Y 50/02; B33Y 10/00

(52) U.S. Cl. CPC H04W 4/008; G05B 19/4099; G05B 2219/49007; G05B 2219/35134; B33Y 10/00; B29L 2031/753; B33Y 50/02; B33Y 30/00; G06F 2217/12

(57) ABSTRACT

The present invention relates to a method and system for manufacturing a compensator for total body irradiation using a camera, and more particularly, to a method and system for manufacturing a patient-tailored compensator of accurate values using a 3D printer based on information acquired through a camera including a space depth sensor and a motion tracking sensor to perform a precise treatment by minimizing the error that can be generated during the treatment. According to one aspect of the present invention, an apparatus for manufacturing a compensator applied to a treatment using total body irradiation (TBI) may include: a first sensor for sensing a space depth of a body of a patient; a second sensor for tracking and sensing a motion of the patient; a depth camera for generating three-dimensional scan information on the body of the patient using the information sensed by the first sensor and the second sensor; and a 3D printer for manufacturing the compensator using the three-dimensional scan information.

### BACKGROUND OF THE INVENTION

### Field of the Invention

The present invention relates to a method and system for manufacturing a compensator for total body irradiation using a camera, and more particularly, to a method and system for manufacturing a patient-tailored compensator of accurate values using a 3D printer based on information acquired through a camera including a space depth sensor and a motion tracking sensor to perform a precise treatment by minimizing the error that can be generated during the treatment.

### Background of the Related Art

Radiation therapy is a technique of treating a disease using radiation, which is one of three major oncology therapies together with surgery and chemotherapy.

Particularly, therapeutic radiation among the radiation used for medical purposes is emitted onto tumors of a cancer patient to make cancer cells not to grow any more so that the cancer cells reach the end of life and die or pains of the patient can be alleviated.

When the cancer cells are highly likely to remain after an operation, the radiation therapy can be performed to prevent recurrence of the cancer, or when an operation cannot be performed, or when the radiation therapy is more effective than the operation, or when it is desired to enhance quality of life of a patient by combining the operation and the radiation therapy, the radiation therapy can be performed to maximize the anti-cancer effect together with cancer chemotherapy after the cancer chemotherapy is performed.

As a method of the radiation therapy, total body irradiation (TBI) is a method of emitting radiation on the whole body or on a portion of the body almost as large as the whole body, and it can be used for treatment of a disease case in which tumors are spread all over the body (such as a case of leukemia, polycythemia vera or the like), neuroblastoma, Wilms' tumor or the like.

In the case of the total body irradiation (TBI), since radiation is emitted from the lateral side of a patient and distribution of the radiation emitted on each part of the human body appears to be different according to the contour of the body, a uniform dose of the radiation should be delivered to all over the body by using a compensator for each part of the body.

In addition, before the total body irradiation is performed, a radiation field confirmation image (linac gram) is photographed to confirm whether or not the compensator is correctly set on each part of the body of a patient.

Such a tissue compensator is made of a material such as aluminum or lead and performs a function of delivering the radiation to be uniformly distributed on the curved parts of the human body.

However, currently, the tissue compensator is manufactured on the basis of rule of thumb by attaching several layers of thin lead stored in a clinic to different parts of the body in different ways, and labors are required for an extended period of time to manufacture the tissue compensator.

In addition, there is a problem in that although the compensators are required to have an accurate depth and length at all parts of a patient, the compensators are manufactured based on the information roughly measured by the eyes of a person.

As a result, since the compensators manufactured using inaccurate values generate an error in calculating a dose, a method capable of solving this problem is required.

### SUMMARY OF THE INVENTION

An object of the present invention is to provide a method and system for manufacturing a compensator for total body irradiation using a camera.

Specifically, an object of the present invention is to provide a user with a method and system for manufacturing a patient-tailored compensator of accurate values using a 3D printer based on information acquired through a camera including a space depth sensor and a motion tracking sensor to perform a precise treatment by minimizing the error that can be generated during the treatment.

Meanwhile, the technical problems to be solved in the present invention are not limited to those mentioned above, and unmentioned other technical problems can be clearly understood by those skilled in the art from the following descriptions.

To accomplish the above objects, according to one aspect of the present invention, there is provided an apparatus for manufacturing a compensator applied to a treatment using total body irradiation (TBI), the apparatus including: a first sensor for sensing a space depth of a body of a patient; a second sensor for tracking and sensing a motion of the patient; a depth camera for generating three-dimensional scan information on the body of the patient using the information sensed by the first sensor and the second sensor; and a 3D printer for manufacturing the compensator using the three-dimensional scan information.

In addition, the three-dimensional scan information may include information on a length and a depth of a plurality of parts included in the body of the patient.

In addition, the compensator may be manufactured to accomplish uniform distribution of radiation on the body of the patient based on dose distribution when the total body irradiation is performed.

In addition, the three-dimensional scan information may be a three-dimensional data of a point cloud shape, and the apparatus may further include a control unit for converting the three-dimensional data of the point cloud shape into a three-dimensional data of a mesh shape.

To accomplish the above objects, according to another aspect of the present invention, there is provided a method of manufacturing a compensator applied to a treatment using total body irradiation (TBI), the method including the steps of: sensing a space depth of a body of a patient; tracking and sensing a motion of the patient; generating three-dimensional scan information on the body of the patient using the sensed space depth information and motion information; and manufacturing the compensator using a 3D printer based on the three-dimensional scan information, in which the three-dimensional scan information may include information on a length and a depth of a plurality of parts included in the body of the patient, and the compensator may be manufactured to accomplish uniform distribution of radiation on the body of the patient based on dose distribution when the total body irradiation is performed.

### BRIEF DESCRIPTION OF THE DRAWINGS

FIG. 1a is a graph showing the characteristic of dose delivery of particle radiation in a medium in relation to the present invention, and FIG. 1b is a comparison view showing that penetration depth of a particle beam into a human body varies according to thickness of a compensator.

FIG. 2 is a perspective view showing a variable compensator currently used for particle beam therapy.

FIG. 3 is a block diagram showing the configuration of a system for manufacturing a compensator for total body irradiation using a camera, proposed in the present invention.

FIG. 4 is a flowchart illustrating the process of manufacturing a compensator for total body irradiation using a camera and performing a radiation treatment through the system described in FIG. 3.

FIG. 5 is a view showing an example of a result of three-dimensional scanning and mapping of the body of a patient through a camera before a compensator is manufactured according to the invention.

FIG. 6 is a view showing a specific example of a custom-tailored compensator manufactured using a 3D printer based on the three-dimensionally scanning and mapping result described in FIG. 5.

### DETAILED DESCRIPTION OF THE PREFERRED EMBODIMENT

In treating a tumor using radiation, determination of a treatment dose is more important than anything else.

In addition, the determined treatment dose and whether or not a dose permitted for an important organ is exceeded should be confirmed without fail.

Total body irradiation (TBI) is frequently used for eradication of cancer cells and immunosuppression of a recipient as one of pretreatment methods for transplanting hematopoietic stem cells, which is currently used as a method for treating leukemia.

Furthermore, the total body irradiation is used as an effective treatment method for malignant tumors such as neuroblastoma, Wilms' tumor, E-wing's sarcoma, malignant lymphoma, leukemia and the like.

Importance of the total body irradiation is further increased after a study reported that transplant of bone marrow has been done successfully.

In addition, the clinical treatment effect of the total body irradiation is gradually increased owing to the biological characteristics of the leukemia and development of radiation therapy techniques, and further accurate and effective radiation therapy can be achieved by irradiating a uniform dose on all over the body.

On the other hand, a further comprehensive attention is required for the total body irradiation, compared with general radiation therapy.

Unlike a general treatment, the radiation should be emitted on all over the body, and since an absorbed dose of each part of a human body requires comparatively uniform dose distribution (±10%), a special treatment environment is needed for this purpose.

The method of performing the total body irradiation can be largely divided into two methods, and the first one is an anterior-posterior parallel opposing portals technique, and the second one is a bilateral parallel opposing portals technique.

At this point, the first thing to be considered is emitting the same dose of radiation on all the parts such as the head, the neck, the mediastinum, the navel, the pelvis, the knees, the ankles, the lungs and the like.

Although it is recommended in a report of the American Association of Physicists in Medicine to uniformly distribute radiation within ten per cents around the center of a human body on the basis of dose distribution when the total body irradiation is performed, actually measured radiation distribution shows a considerable difference at each part of the body.

Data on a patient needed for total body irradiation includes the length and depth of each part of the body of a patient, and such data are used for manufacturing a compensator applied to the patient and calculating a radiation dose.

A compensator or a tissue compensator is used to make a uniform distribution of radiation while compensating the difference in the distribution of radiation transferred to the whole body, and such a tissue compensator is made of a material such as aluminum or lead and performs a function of delivering the radiation to be uniformly distributed on the curved parts of the human body.

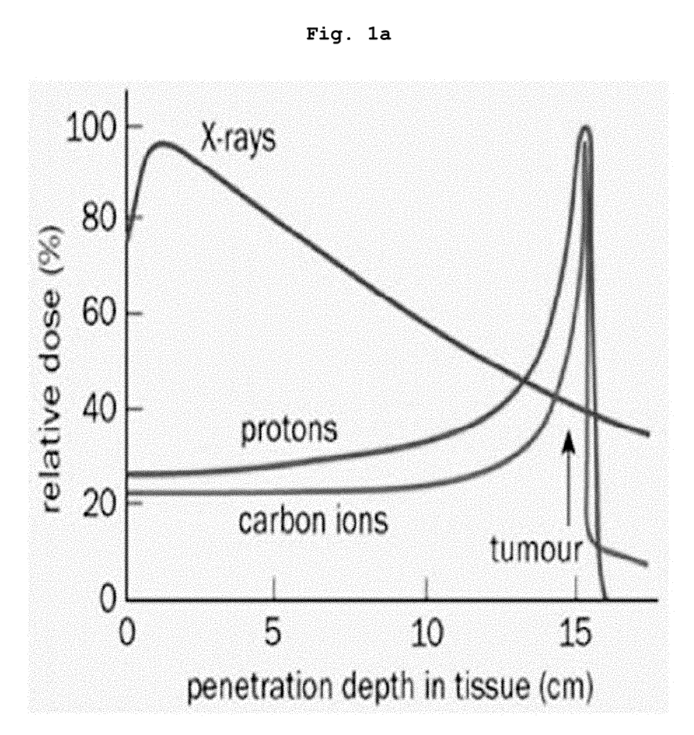

FIG. 1a is a graph showing the characteristic of dose delivery of particle radiation in a medium in relation to the present invention, and FIG. 1b is a comparison view showing that penetration depth of a particle beam into a human body varies according to thickness of a compensator.

Unlike the X-ray, since particle radiation such as a proton beam or a carbon ion beam has a peculiar characteristic of dose delivery called as the Bragg peak, it has an advantage of delivering a large amount of radiation to a tumor and protecting normal organs in the neighborhood when the particle radiation is used for radiation therapy.

As shown in FIG. 1a, comparing the dose delivery characteristic of the particle radiation in a medium with that of the X-ray, high energy transfer occurs near the surface of the medium in the case of the X-ray, whereas high energy transfer occurs only at a specific depth in the case of the particle beam, and thus in the current particle beam therapy, a patient is treated by spatially modulating the particle beam mainly through a method of double scattering and penetration depth modulation (range modulation) of the beam.

At this point, since a shape of a tumor is different from patient to patient, in a particle beam therapy, a compensator which adjusts penetration depth distribution of the particle radiation is used to deliver the radiation dose only to a target.

The particle radiation passing through a thin part of the compensator penetrates deep into a human body, and when the particle radiation passes through a thick part of the compensator, penetration depth into the human body is low, and thus distribution of the radiation dose corresponds to the depth direction shape of a tumor.

That is, as shown in FIG. 1b, since penetration depth of a particle beam into a human body is large at a thin part of the compensator and the penetration depth is small at a thick part of the compensator owing to the action of the compensator, distribution of the radiation dose is adjusted in the depth direction.

As for the compensator, a solid polymer material such as Polymethly Methacrylate (PMMA) or the like or a flexible material such as wax or the like is processed to fit to a treatment portion of a patient using a milling machine and used for treatment as a conventional compensator.

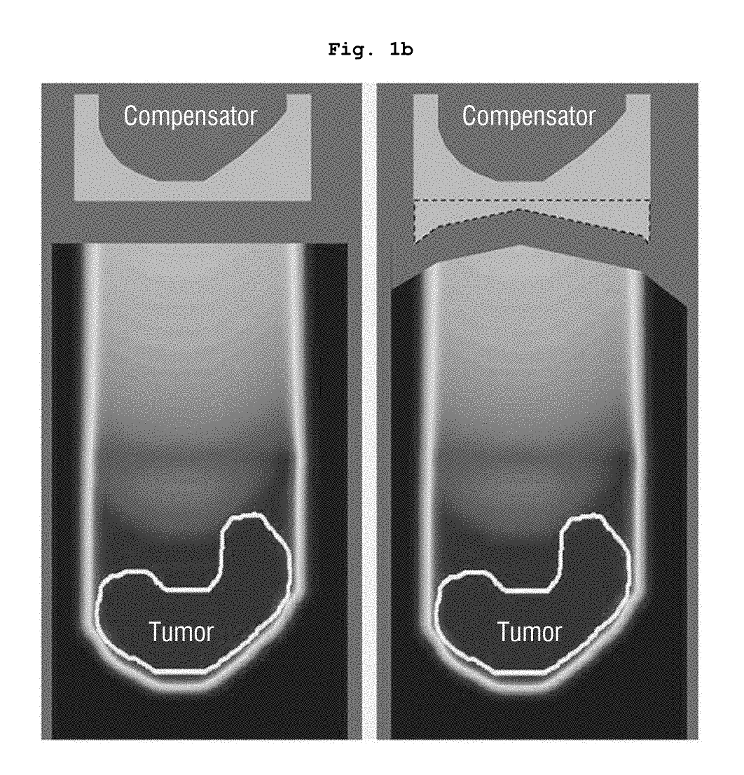

FIG. 2 is a perspective view showing a variable compensator currently used for particle beam therapy.

Referring to FIG. 2, the variable compensator for particle beam therapy of the prior art includes a fixed frame 1, a variable element 2, a variable means 3 and a controller 4 as a basic configuration.

The fixed frame 1 is filled with a gas or a liquid and preferably includes a frame 5 of a barrier structure forming a plurality of guide barriers 5a filled with a gas or a liquid. A fluid such as a liquid or a gas is filled in the guide barriers 5a, and the liquid or gas filled in the guide barriers 5a acts as a variable element 2 having a shape changed by the variable means 3.

The variable element 2 is a constitutional component formed as a plurality of liquid columns or gas columns of a liquid or a gas filled in each guide barrier 5a of the frame 5 of the barrier structure placed on a printed circuit board (PCB), i.e., the controller 4, and the lower part of each guide barrier 5a of the frame 5 of the barrier structure is individually connected to a supply valve 6 for supplying a liquid or a gas, and the liquid or the gas is selectively filled in each guide barrier 5a of the frame 5 of the barrier structure through the supply valve 6 by way of a supply tube 7.

A representative gas which forms the gas column is air, and the gas column may be formed as an air column or a gaseous column formed by various kinds of gases other than the air.

Each guide barrier 5a of the frame 5 of the barrier structure may be formed to have a cross section of a hexagonal shape besides a rectangular shape, and it can be formed in a variety of shapes such as a polygonal shape or the like including a circular or pentagonal shape other than the rectangular or hexagonal shape.

The variable means 3 is a constitutional component including a fine adjustment valve formed under each guide barrier 5a of the frame 5 of the barrier structure, in which the liquid column or the gas column, i.e., the variable element 2, is formed, and the fine adjustment valve is connected to the printed circuit board (PCB) to change the shape of the liquid column or the gas column. The length of the variable means 3 is changed by selectively adjusting the amount of the liquid or the gas of the liquid column or the gas column filled in each guide barrier 5a of the frame 5 of the barrier structure by using the fine adjustment valve so that the compensator can be used as a variable compensator.

The fine adjustment valve, which is the variable means 3, finely adjusts the amount of the liquid or the gas forming the liquid column or the gas column by using one of a piezoelectric crystal, a piezoelectric thin film and a piezoelectric element which can be electrically or electronically controlled or by using a valve, a micro motor or an electromagnetic valve using the piezoelectric crystal, the piezoelectric thin film or the piezoelectric element.

However, since such a compensator is a patient-tailored type, it should be individually manufactured for each patient and cannot be reused for other patients after treatment, and in addition, if the number of beam directions used for treatment is increased even in the same patient, compensators as many as the number of beam directions should be manufactured.

Therefore, high expenditure on the material cost will be generated continuously according thereto, and since the time required for manufacturing the compensator is considerably long, there is a problem in treating a lot of patients at the same time or promptly treating emergency patients.

In addition, when two or more beams are used, there is a risk of providing a treatment using a wrong compensator by a human error.

That is, although a solid compensator used for radiation therapy should be individually manufactured for each patient and cannot be reused for other patients and compensators as many as the number of beam directions should be manufactured for the same patient, use of diverse beam directions is limited in reality in an actual treatment of a patient. Accordingly, the time and cost required for manufacturing the compensators and the limitation in the number of available compensators greatly lower the quantitative efficiency in the number of patients treated per unit time and increase the financial burden of the patients.

In addition, since a conventional compensator cannot adjust the spatial penetration depth of a particle beam with respect to time, there is a problem in that it cannot implement a high-tech treatment technique such as an arc therapy, an intensity-modulated particle beam therapy, an intensity-modulated particle radiation arc therapy or the like.

In addition, currently, the tissue compensator is manufactured on the basis of rule of thumb by attaching several layers of thin lead stored in a clinic to different parts of the body in different ways, and labors are required for an extended period of time to manufacture the tissue compensator.

In addition, there is a problem in that although the compensators are required to have an accurate depth and length at all parts of a patient, the compensators are manufactured based on the information roughly measured by the eyes of a person.

As a result, the compensators manufactured using inaccurate values generate an error in calculating a dose.

Therefore, the present invention has been made in view of the above problems, and it is an object of the present invention to provide a method and system for manufacturing a compensator for total body irradiation using a camera.

Specifically, an object of the present invention is to provide a user with a method and system for manufacturing a patient-tailored compensator of accurate values using a 3D printer based on information acquired through a camera including a space depth sensor and a motion tracking sensor to perform a precise treatment by minimizing the error that can be generated during the treatment.

Before describing the method according to the present invention, a system for manufacturing a compensator for total body irradiation using a camera, which can be applied to the present invention, will be described in detail.

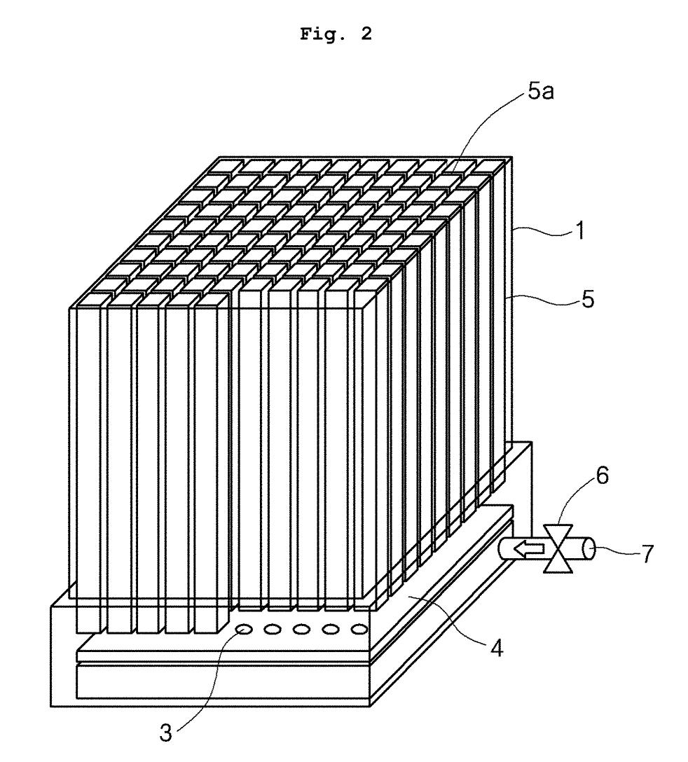

FIG. 3 is a block diagram showing the configuration of a system for manufacturing a compensator for total body irradiation using a camera, proposed in the present invention.

Referring to FIG. 3, a system 100 for manufacturing a compensator using a camera may include a wireless communication unit 110, an Audio/Video (A/V) input unit 120, a user input unit 130, a sensing unit 140, an output unit 150, a memory 160, an interface unit 170, a controller 180, a power supply unit 192 and the like.

However, since the constitutional components shown in FIG. 3 are not essential, a system having more constitutional components or fewer constitutional components can be implemented.

Hereinafter, the constitutional components will be described one by one.

The wireless communication unit 110 may include one or more modules, which make wireless communication possible between the system for manufacturing a compensator using a camera and a wireless communication system or between a device and a network where the device is located.

For example, the wireless communication unit 110 may include a broadcast receiving module 111, a mobile communication module 112, a wireless Internet module 113, a short range communication module 114, a position information module 115 and the like.

The broadcast receiving module 111 receives a broadcasting signal and/or broadcasting related information from an external broadcasting management server through a broadcasting channel.

The broadcasting channel may include a satellite channel and a terrestrial channel. The broadcasting management server may be a server for creating and transmitting a broadcasting signal and/or broadcasting related information or a server for receiving a previously created broadcasting signal and/or broadcasting related information and transmitting the signal or the information to the system for manufacturing a compensator using a camera. The broadcasting signal may include a TV broadcasting signal, a radio broadcasting signal and a data broadcasting signal and, in addition, a broadcasting signal of a form combining the TV broadcasting signal or the radio broadcasting signal with the data broadcasting signal.

The broadcasting related information may be information related to a broadcasting channel, a broadcasting program or a broadcasting service provider. The broadcasting related information may also be provided through a mobile communication network. In this case, the broadcasting related information can be received by the mobile communication module 112.

The broadcasting related information may exist in a variety of forms. For example, it may exist in the form of Electronic Program Guide (EPG) of Digital Multimedia Broadcasting (DMB), Electronic Service Guide (ESG) of Digital Video Broadcast-Handheld (DVB-H) or the like.

The broadcast receiving module 111 may receive a digital broadcasting signal using a digital broadcasting system such as Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) or the like. Of course, the broadcast receiving module 111 may be configured to be suitable for other broadcasting systems, as well as the digital broadcasting systems described above.

The broadcasting signal and/or the broadcasting related information received through the broadcast receiving module 111 may be stored in the memory 160.

The mobile communication module 112 transmits and receives wireless signals to and from at least one of a base station, an external device and a server on the mobile communication network.

The wireless signal may include various forms of data according to transmission and reception of a character/multimedia message.

The wireless Internet module 113 is a module for wireless Internet connection and may be internally or externally coupled to the system for manufacturing a compensator using a camera. Wireless LAN (WLAN) (Wi-Fi), Wireless broadband (Wibro), World Interoperability for Microwave Access (Wimax), High Speed Downlink Packet Access (HSDPA) or the like may be used as a technique of the wireless Internet.

The short-range communication module 114 is a module for short range communication. Bluetooth, Radio Frequency Identification (RFID), infrared Data Association (IrDA), Ultra Wideband (UWB), ZigBee, Wireless Fidelity (Wi-Fi) or the like can be used as a technique of the short-range communication.

The position information module 115 is a module for acquiring the location of the system for manufacturing a compensator using a camera, and a representative example thereof is a Global Position System (GPS) module.

Referring to FIG. 3, the Audio/Video (A/V) input unit 120 is a constitutional component for inputting an audio signal or a video signal and may include a camera 121 and a MIC 122. The camera 121 processes an image frame of a still image or a video obtained by an image sensor in a photographing mode. The processed image frame may be displayed on a display unit 151.

The image frame processed by the camera 121 may be stored in the memory 160 or transmitted to outside through the wireless communication unit 110. Two or more cameras 121 can be provided according to a use environment.

Meanwhile, the camera 121 may provide a function of photographing a depth in order to photograph three-dimensional information as a picture or an image.

The first one devised as a depth camera is a camera of a photodiode (PD; a semiconductor diode which generates light when it is exposed to light) or vidicon type.

In addition, the advent of a Charged Coupled Device (CCD) array has contributed to remarkable advancement in equipment for measuring three-dimensional range information.

A 3D laser scanner of a triangulation method, a depth camera using a structured light pattern, a depth camera of a Time-Of-Flight (TOF) method using reflection time difference of Infra-Red (IR) rays and the like are commercialized and released as a product and can be applied to the present invention.

A method of using a 3D laser scanner is arranging scanners around a target object or a scene to be measured, obtaining range images from several directions while changing the scanning positions, and obtaining a three-dimensional model by integrating the images in a three-dimensional space.

In the case of the scene, a piece of scanner equipment is mounted on an autonomous mobile robot, and the robot moves around a space for collecting images and obtains range images, and then a three-dimensional model is created by registration of the data.

Representative three-dimensional range scanner products are released from Cyberware of USA and Wicks & Wilson of the United Kingdom.

As a technique of creating a three-dimensional model of an object using the collected range images, there is a method proposed by Wheeler et al. of USA.

For example, it is a technique of reconfiguring a three-dimensional model of an object by aligning positions of images photographed at different time points and merging the images, which collects three-dimensional data of a point cloud shape and reconfigures a model.

The three-dimensional model is also created by merging silhouette images obtained from various points of sight.

Next, as a method using a structured light pattern, a method proposed to enhance the accuracy of calculating corresponding points between stereo images needed in a traditional stereo vision can be used.

This is a method of projecting a pattern having a predetermined rule onto an object or a scene to be three-dimensionally restored through a beam projector, photographing an image using a camera and obtaining a correspondence relation from the image.

In addition, commercialized depth camera products of a TOF method using reflection time difference of IR rays are released one after another.

Such a depth camera calculates range information in the TOF method of radiating a laser or an infrared ray onto an object or a target area, receiving returning rays and calculating time difference of the rays.

These cameras may obtain depth information by the unit of pixel of a CCD camera image and thus can be utilized to collect real-time depth information of a moving object or a scene of a 3D TV or the like.

In addition, a camera applying the technique of Google Project Tango can be used.

The Project Tango of Google publicized in late 2014 is designed to three-dimensionally scan and map the environment surrounding a user by mounting a depth sensor capable of measuring depth of a space in a general camera and combining a motion tracking sensor capable of tracking a motion.

In a recording mode, a voice recognition mode or the like, the MIC 122 receives an external audio signal through a microphone and processes the audio signal into an electrical voice data. The processed voice data may be converted into a transmittable form and output to a mobile communication base station through the mobile communication module 112. A variety of noise suppression algorithms for removing noises generated in the process of receiving an external audio signal can be implemented in the MIC 122.

The user input unit 130 generates an input data for controlling operation of the system for manufacturing a compensator using a camera. The user input unit 130 may be configured of a keypad, a dome switch, a touch pad (resistive/capacitive), a jog wheel, a jog switch or the like.

The sensing unit 140 senses current states of the system for manufacturing a compensator using a camera, such as an open and close state of the system for manufacturing a compensator using a camera, a location of the system for manufacturing a compensator using a camera, whether or not the system for manufacturing a compensator using a camera contacts with a user, an orientation of the system for manufacturing a compensator using a camera, acceleration and deceleration of the system for manufacturing a compensator using a camera and the like, and generates a sensing signal for controlling the operation of the system for manufacturing a compensator using a camera.

The sensing unit 140 may sense whether or not power of the power supply unit 192 is supplied, whether or not the interface unit 170 is connected to an external device or the like.

The sensing unit 140 may include a depth sensor capable of measuring depth of a space, a motion tracking sensor capable of tracking a motion and the like in order to support application of a camera which applies the Google Project Tango described above, and the sensing unit 140 may three-dimensionally scan and map the surrounding environment of a user through these sensors.

Meanwhile, the sensing unit 140 may include a proximity sensor 141.

The output unit 150 is a constitutional component for generating an output related to sight, hearing, touch or the like and may include a display unit 151, an audio output module 152, an alarm unit 153, a haptic module 154, a projector module 155 and the like.

The display unit 151 displays (outputs) information processed in the system for manufacturing a compensator using a camera.

The display unit 151 may include at least one of a liquid crystal display (LCD), a thin film transistor-liquid crystal display (TFT LCD), an organic light-emitting diode (OLED) display, a flexible display and a 3D display.

Among these, some of the displays may be configured as a transparent type or a light transmission type so as to see the outside through the display. This may be referred to as a transparent display, and a representative example of the transparent display is a transparent OLED (TOLED). The rear structure of the display unit 151 may also be configured as a light transmission structure. According to such a structure, a user may see an object placed behind the body of the system for manufacturing a compensator using a camera through an area occupied by the display unit 151 of the body of the system for manufacturing a compensator using a camera.

Two or more display units 151 may exist according to the implementation form of the system for manufacturing a compensator using a camera. For example, a plurality of display units may be arranged on one side of the system for manufacturing a compensator using a camera to be spaced apart from each other or to be integrated with each other, or they may be arranged on different sides.

When the display unit 151 and a sensor for sensing a touch action (hereinafter, referred to as a ‘touch sensor’) form a layer structure with each other (hereinafter, referred to as a ‘touch screen’), the display unit 151 can be used as an input device as well as an output device. The touch sensor may have a form of, for example, a touch film, a touch sheet, a touch pad or the like.

The touch sensor may be configured to convert change of pressure applied to a specific portion of the display unit 151, capacitance generated at a specific portion of the display unit 151 or the like into an electrical input signal. The touch sensor may be configured to detect even a pressure, as well as a touched position and area, when the display unit 151 is touched.

If there is a touch input on the touch sensor, a signal (signals) corresponding to the touch input is sent to a touch controller. The touch controller processes the signal (signals) and then transmits corresponding data to the controller 180. Therefore, the controller 180 knows which area of the display unit 151 is touched.

The proximity sensor 141 may be arranged in an inner area of the system for manufacturing a compensator using a camera surrounded by the touch screen or in the neighborhood of the touch screen. The proximity sensor refers to a sensor, which detects existence of an object approaching a predetermined detection surface or an object existing in the neighborhood using an electromagnetic force or an infrared ray without a mechanical contact. The proximity sensor has a long lifespan and its utilization is high, compared with a contact type sensor.

Examples of the proximity sensor include a transmissive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. When the touch screen is the electrostatic capacity proximity sensor, it is configured to detect approach of a pointer based on the change of electric field according to the approach of the pointer. In this case, the touch screen (touch sensor) may be classified as a proximity sensor.

Hereinafter, for the convenience of explanation, a behavior of approaching a pointer near the touch screen without touching the touch screen so that the pointer may be recognized as being located on the touch screen is referred to as a “proximity touch”, and a behavior of actually contacting the pointer with the touch screen is referred to as a “contact touch”. A position on the touch screen proximately touched by the pointer means a position on the touch screen vertically corresponding to the pointer when the pointer is proximately touched.

The proximity sensor detects a proximity touch and a proximity touch pattern (e.g., a proximity touch distance, a proximity touch direction, a proximity touch speed, a proximity touch duration, a proximity touch position, a proximity touch shift state, and the like). Information corresponding to the detected proximity touch action and the detected proximity touch pattern may be output on the touch screen.

The audio output module 152 may output audio data received from the wireless communication unit 110 or stored in the memory 160 in a recording mode, a voice recognition mode, a broadcast reception mode or the like. The audio output module 152 may also output audio signals related to a function performed in the system for manufacturing a compensator using a camera. The audio output module 152 may include a receiver, a speaker, a buzzer and the like.

The alarm unit 153 outputs a signal for informing generation of an event in the system for manufacturing a compensator using a camera.

The alarm unit 153 may also output a signal for informing generation of an event in a form other than a video signal or an audio signal, e.g., vibration.

Since the video signal or the audio signal can be output through the display unit 151 or the voice output module 152, they 151 and 152 can be classified as a part of the alarm unit 153.

The haptic module 154 generates various haptic effects that can be felt by a user. A representative example of the haptic effects generated by the haptic module 154 is vibration. The strength, pattern and the like of the vibration generated by the haptic module 154 can be controlled.

For example, different vibrations can be output after being synthesized, or they can be output sequentially.

The haptic module 154 may generate various haptic effects, in addition to the vibration, such as an effect generated by a stimulus of a pin array moving vertically with respect to a contacting skin surface, a force of injecting or sucking air through an injection hole or a suction hole, grazing the skin surface, contact of an electrode, electrostatic force or the like, an effect generated by reproduction of a cold or warm feeling using an element capable of absorbing or generating heat, or other effects.

The haptic module 154 may be implemented to deliver the haptic effect through direct contact or to make a user feel the haptic effect through a muscular sense of a finger, an arm or the like. Two or more haptic modules 154 can be provided according to the configuration of the system for manufacturing a compensator using a camera.

The projector module 155 is a constitutional component for performing an image project function using the system for manufacturing a compensator using a camera and may display an image the same as or at least partially different from an image displayed on the display unit 151 on an external screen or a wall according to a control signal of the controller 180.

Specifically, the projector module 155 may include a light source (not shown) for generating light (e.g., a laser beam) for outputting an image to outside, an image creation means (not shown) for creating an image to be output to outside using the light generated by the light source, and a lens (not shown) for enlarging and outputting the image to outside at a predetermined focal distance. In addition, the projector module 155 may include a device (not shown) for adjusting an image project direction by mechanically moving the lens or the whole module.

The projector module 155 may be divided into a cathode ray tube (CRT) module, a liquid crystal display (LCD) module, a digital light processing (DLP) module and the like according to the element type of a display means. Particularly, the DLP module uses a method of enlarging and projecting an image created as the light generated by a light source is reflected by a digital micromirror device (DMD) chip, and it may be advantageous to miniaturization of the projector module 155.

Preferably, the projector module 155 may be provided on the lateral side, the front side or the rear side of the system for manufacturing a compensator using a camera in the longitudinal direction. Of course, it is natural that the projector module 155 can be provided at any position of the system for manufacturing a compensator using a camera as needed.

The memory 160 may store a program for processing and controlling the controller 180 and perform a function for temporarily storing input and output data (e.g., a message, an audio, a still image, a moving image and the like). The memory 160 may also store a frequency of using each of the data. In addition, the memory 160 may also store data related to vibration and sounds of various patterns output when a touch is input on the touch screen.

The memory 160 may include at least one type of storage media among a flash memory type medium, a hard disk type medium, a multimedia card micro type medium, a card type memory (e.g., SD or XD memory or the like), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The system for manufacturing a compensator using a camera may operate in relation to a web storage, which performs a storage function of the memory 160 on the Internet.

The interface unit 170 functions as a passage to all external devices connected to the system for manufacturing a compensator using a camera. The interface unit 170 receives data from the external devices, receives and transfers power to each constitutional component in the system for manufacturing a compensator using a camera, or transmits data internal to the system for manufacturing a compensator using a camera to the external devices. For example, the interface unit 170 may include a wired or wireless headset port, an external recharger port, a wired or wireless data port, a memory card port, a port for connecting a device provided with an identification module, an audio input and output (I/O) port, a video input and output (I/O) port, an earphone port and the like.

The identification module is a chip which stores various kinds of information for authenticating a right for using the system for manufacturing a compensator using a camera and may include a User Identify Module (UIM), a Subscriber Identity Module (SIM), a Universal Subscriber Identity Module (USIM) or the like. A device provided with the identification module (hereinafter, referred to as an ‘identification device’) may be manufactured in the form of a smart card. Therefore, the identification device can be connected to the system for manufacturing a compensator using a camera through a port.

When the system for manufacturing a compensator using a camera is connected to an external cradle, the interface unit becomes a passage for supplying power of the cradle to the system for manufacturing a compensator using a camera or a passage for delivering various command signals input from the cradle by a user to a mobile device. The various command signals or the power input from the cradle may function as a signal for recognizing that the mobile device is correctly mounted on the cradle.

Generally, the controller 180 controls the overall operation of the system for manufacturing a compensator using a camera.

The controller 180 may be provided with a multimedia module 181 for playback of multimedia. The multimedia module 181 may be implemented inside the controller 180 or implemented to be separated from the controller 180.

The controller 180 may perform a pattern recognition process for recognizing a writing input and a picture drawing input carried out on the touch screen as characters or images, respectively.

The power supply unit 192 is supplied with external power or internal power and supplies power needed for operation of each constitutional component under the control of the controller 180.

Various embodiments described herein may be implemented, for example, inside a recording medium, which can be read by a computer or a device similar to the computer using software, hardware or a combination of these.

According to hardware implementation, the embodiments described herein may be implemented using at least one of application specific integrated circuits (ASICs), digital signal processors (DSPs), digital signal processing devices (DSPDs), programmable logic devices (PLDs), field programmable gate arrays

(FPGAs), processors, controllers, microcontrollers, microprocessors, and electrical units for performing other functions. In some case, the embodiments described in this specification can be implemented as the controller 180 itself.

According to software implementation, the embodiments such as the procedures and functions described in this specification may be implemented as separate software modules. Each of the software modules may perform one or more functions and operations described in this specification. A software code can be implemented as a software application written in a suitable program language. The software code may be stored in the memory 160 and executed by the controller 180.

In addition, the system according to the present invention may further include a 3D printer 195.

The 3D printer 195 is a device for manufacturing a three-dimensional stereoscopic object based on an input drawing, as if a 2D printer prints characters or pictures.

Its principle is the same as the principle of printing a 2D image (characters or pictures) at an inkjet printer by injecting ink on the surface of a paper when a digitalized file is transmitted.

The 2D printer only moves back and force (X-axis) and left and right (Y-axis), whereas the 3D printer manufactures a three-dimensional object based on an input 3D drawing by adding a vertical (Z-axis) movement.

According to the method of making a three-dimensional shape, the 3D printer 195 is largely divided into a stacking type of piling up layers one by one (an addition type or a rapid prototype method) and a cutting type of cutting off a large lump (a computer numerical control carving method).

Here, the stacking type is a method of making a three-dimensional shape by piling up powder (flakes of plaster, nylon or the like), plastic liquid or plastic strings in layers of 0.01 to 0.08 mm thinner than a paper.

In addition, the thinner the layers are, a more precise shape can be obtained, and painting can be progressed simultaneously.

The cutting type is a method of making a three-dimensional shape by cutting a large lump, like doing a carving.

Although the cutting type is advantageous in that a finished object is more precise compared to those of the stacking type, it is disadvantageous in that a lot of materials are consumed, a shape hollowed out like a cup is difficult to manufacture, and a painting work should be done separately.

The manufacturing process includes the steps of modeling, printing and finishing an object.

Modeling is a step of making a 3D drawing using a 3D computer aided design (CAD), a 3D modeling program, a 3D scanner or the like.

Printing is a step of manufacturing an object using the 3D drawing created in the modeling process, and the work is progressed in a stacking method, a cutting method or the like.

Finishing is a step of performing a supplementary work on the manufactured product, in which a work such as painting the product, grinding the surface of the product, assembling partial products or the like is progressed.

The 3D printer is originally developed for the purpose of making a prototype in an enterprise before commercializing a product. It is known that a printer for manufacturing a three-dimensional object by hardening plastic liquid was developed for the first time in early 1980s by 3D Systems of USA. Developed from the early stage limited to a plastic material, its range has been expanded to nylon and metal materials, and it has entered the commercialization stage in a variety of fields, in addition to the industrial prototype.

In the present invention, a depth sensor, a motion tracking sensor capable of tracking a motion and the like can be included by applying the technique of Google Project Tango described above, and through the sensors, the 3D printer 195 can be used as a means for manufacturing a compensator based on a product resulting from three-dimensional scanning and mapping of the surrounding environment of a user.

In the present invention, a patient-tailored compensator, which can be manufactured within a short period of time using a 3D printer 195, thereby reducing a dose error, can be provided by obtaining accurate values using a portable camera 121.

In order to obtain accurate values of a manufactured tissue compensator, the technique of Google Project Tango can be applied to the present invention.

The Project Tango of Google is designed to three-dimensionally scan and map the environment surrounding a user by mounting a depth sensor capable of measuring depth of a space in a general camera and combining a motion-tracking sensor capable of tracking a motion.

Currently, this in a developer version, and if a surrounding area is photographed using a smart device, the interior of a building or a room can be scanned and stored as a 3D image.

This can be utilized for indoor map creation, a motion recognition game utilizing augmented reality, navigation for visually disabled persons and the like.

According to Google, although a development kit is currently divided into a kit for an indoor map, a kit for sensor analysis, a kit for a game and the like, this is applied to the medical field and utilized for further improved total body irradiation.

The three-dimensional scan data scanned like this is basically configured as a point cloud.

The three-dimensional scan data can be immediately converted into a mesh or can be stored as the point cloud itself.

In addition, an appropriate mesh result is created from irregular and coarse data through a reconfiguration process.

The mesh created like this can be converted into a further perfect form through a post-process and also can be immediately reverse-designed without the post-process.

In relation to manufacturing a 3D-printed compensator, the World Economic Forum selected the 3D printer as the second top when it announced future ten prospective technologies in 2012, and in several countries, the 3D-printing technology is raised as the leader of revolution in the next generation manufacturing industry.

The most essential reason of the 3D printer being spotlighted is that the compensator can be tailor-made using only a small and necessary amount of light material without waste and can be manufactured in an extraordinarily speed way.

Competition among countries for holding a dominant position in the 3D printer market is fiercely developed, and if the 3D printer is generalized, a desired product can be manufactured at any place, and if the 3D printer is fused with other fields, a new industrial field can be developed.

The most prospective field of utilizing the 3D printer is the medical field.

It is since that the effect of customization, which is a feature of the 3D printer, can be most outstandingly achieved in the medical field.

An object of the present invention is to manufacture a desired patient-tailored tissue compensator within a short period of time by inputting scan data of the Google Project Tango into a 3D printer without labor. However, the spirit of the present invention is not limited to manufacturing a compensator based on the scan data of the Tango, but a specific embodiment is presented for further understanding.

The technique proposed in the present invention may establish a proper treatment plan through a camera utilizing a space depth sensor and a motion tracking sensor, manufacture a patient-tailored compensator of accurate values using a 3D printer, and therefore provide a further proper treatment by complementing an error which may occur during the treatment.

Hereinafter, the process of manufacturing a compensator for total body irradiation using a camera and performing a radiation treatment will be described based on the system shown in FIG. 3.

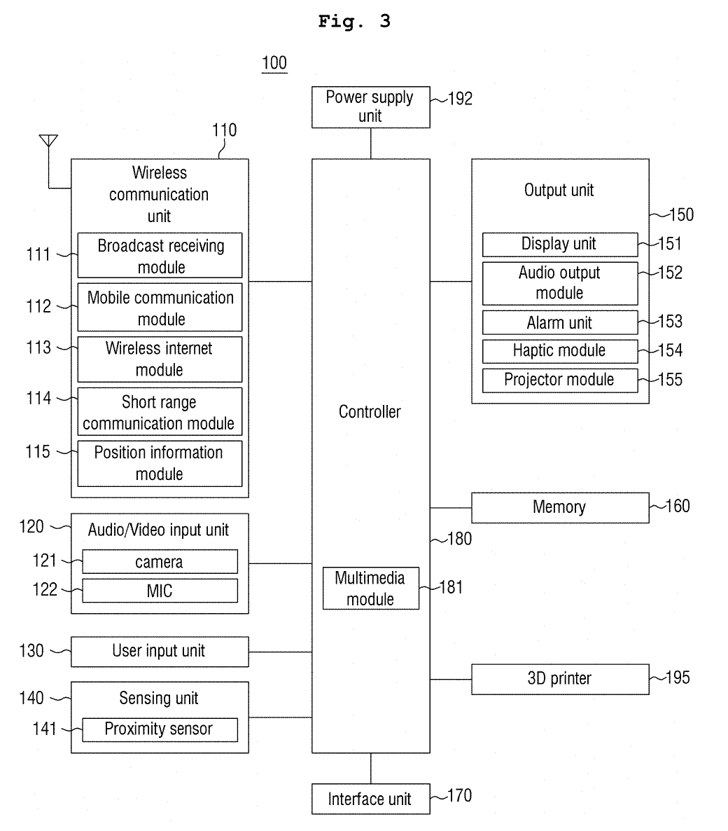

FIG. 4 is a flowchart illustrating the process of manufacturing a compensator for total body irradiation using a camera and performing a radiation treatment through the system described in FIG. 3.

Referring to FIG. 4, a process of acquiring three-dimensional information on a patient through a depth camera 121 is performed (steps S11, S12 and S13).

As shown in FIG. 4, a plurality of pieces of three-dimensional information is obtained according to a pose of a patient to avoid errors and erroneous measurements (steps S11, S12 and S13).

Next, a step of merging the information acquired in the steps of S11, S12 and S13 is performed (step S21), and three-dimensional modeling information is acquired using the merged information (step S22).

A measurement step is progressed based on the information acquired in the step S22 (step S23), and this is connected to the step of grasping thickness of each part of the body of a patient (step S24) and the step of measuring a distance between the patient and a source (step S25).

At this point, properties of a beam output to the patient can be considered together with a material (step S26).

Design information for manufacturing a compensator can be created based on the information obtained in the steps of S24, S25 and S26 (step S27).

Then, the three-dimensional model information of the compensator is determined (step S28), and the determined information is input into the 3D printer 195 (step S31), a three dimensional shape of the compensator is determined through the information (step S32), and silicon modeling is processed (step S33), and a final compensator is manufactured (step S36) through a silicon molding process (step S34) and a process of melting and pouring a mixture of wax and tungsten (step S35).

Then, treatment can be progressed based on the manufactured compensator (step S37).

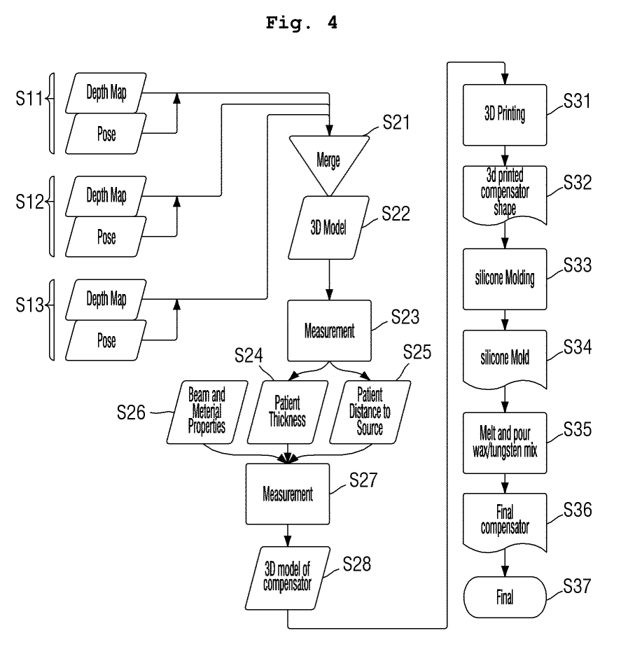

FIG. 5 is a view showing an example of a result of three-dimensional scanning and mapping of the body of a patient through a camera before a compensator is manufactured according to the invention.

FIGS. 5(a) to 5(c) show a result of scanning a body through the steps of S22 to S27.

The results of FIG. 5 are obtained by applying the Project Tango of Google, which is obtained by three-dimensionally scanning and mapping the environment surrounding a user by mounting a depth sensor capable of measuring depth of a space in a general camera and combining a motion tracking sensor capable of tracking a motion.

FIG. 5 shows three-dimensional image products reflecting the length and depth of each part of a body through a depth camera.

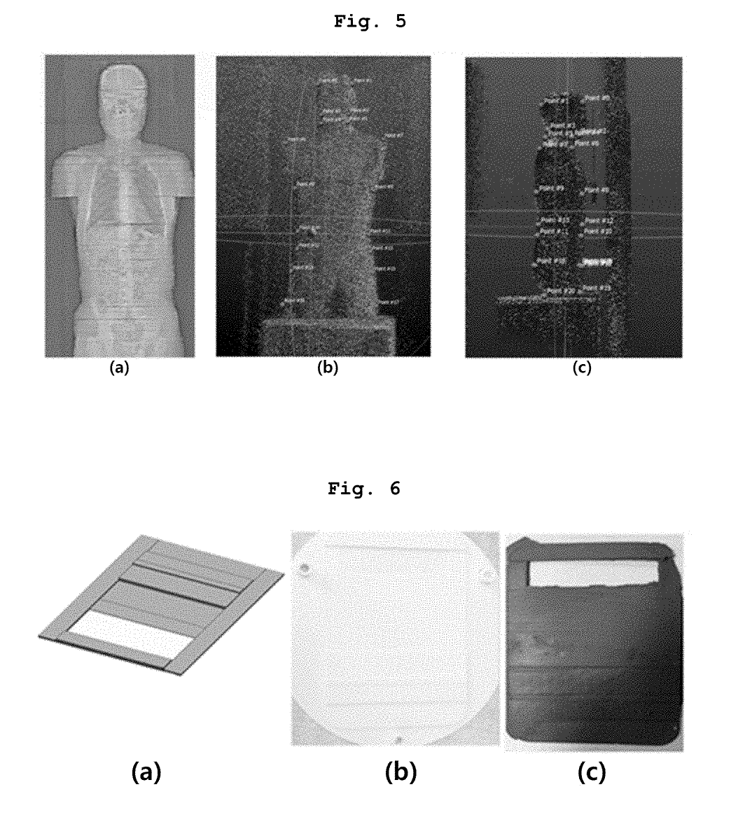

In addition, FIG. 6 is a view showing a specific example of a custom-tailored compensator manufactured using a 3D printer based on the three-dimensionally scanning and mapping result described in FIG. 5.

FIG. 6(a) is a view showing an estimation of a product manufactured through a program using a 3D printer based on a result of three-dimensional scanning and mapping as described in FIG. 5, and FIGS. 6(b) and 6(c) are views showing a result of manufacturing a compensator which can be actually used for a patient.

Through the method and system described above, the present invention may provide a user with a method and system for manufacturing a compensator for total body irradiation using a camera.

That is, the present invention may provide a user with a method and system for manufacturing a patient-tailored compensator of accurate values using a 3D printer based on information acquired through a camera including a space depth sensor and a motion-tracking sensor to perform a precise treatment by minimizing the error that can be generated during the treatment.

The present invention may provide a user with a method and system for manufacturing a compensator for total body irradiation using a camera.

Specifically, the present invention may provide a user with a method and system for manufacturing a patient-tailored compensator of accurate values using a 3D printer based on information acquired through a camera including a space depth sensor and a motion-tracking sensor to perform a precise treatment by minimizing the error that can be generated during the treatment.

Meanwhile, the effects that can be obtained in the present invention are not limited to the effects mentioned above, and unmentioned other effects can be clearly understood by those skilled in the art from the following descriptions.

The detailed description on the embodiments of the present invention disclosed as described above is provided to implement and embody the present invention by those skilled in the art. Although it is described above with reference to the preferred embodiments of the present invention, it is to be appreciated that those skilled in the art can diversely change or modify the present invention without departing from the scope and spirit of the present invention. For example, those skilled in the art may use the configurations described in the embodiments described above in a method of combining the configurations with each other. Accordingly, the present invention is not to be limited to the embodiments appeared herein, but intends to give a broadest scope matching the principles and new features disclosed herein.

The present invention may be embodied in other specific forms without departing from the spirit and essential characteristics of the present invention. Therefore, the detailed description is to be construed as limited to be considered in all respects illustrative devised. The scope of the invention should be determined by reasonable interpretation of the appended claims, and all modifications within equivalent ranges of the present invention are included in the scope of the present invention. The present invention is non-limited by the embodiments disclosed herein but intends to give a broadest scope matching the principles and new features disclosed herein. In addition, the present invention may be embodied by a combination of claims, which do not have an explicit cited relation in the appended claims or may include new claims by amendment after application.

What is claimed is:

1. An apparatus for manufacturing a compensator applied to a treatment using total body irradiation (TBI), the apparatus comprising:
a first sensor for sensing a space depth of a body of a patient;
a second sensor for tracking and sensing a motion of the patient;
a depth camera for generating three-dimensional scan information on the body of the patient using the information sensed by the first sensor and the second sensor; and
a 3D printer for manufacturing the compensator using the three-dimensional scan information.

2. The apparatus according to claim 1, wherein the three-dimensional scan information includes information on a length and a depth of a plurality of parts included in the body of the patient.

3. The apparatus according to claim 1, wherein the compensator is manufactured to accomplish uniform distribution of radiation on the body of the patient based on dose distribution when the total body irradiation is performed.

4. The apparatus according to claim 1, wherein the three-dimensional scan information is a three-dimensional data of a point cloud shape, and the apparatus further includes a control unit for converting the three-dimensional data of the point cloud shape into a three-dimensional data of a mesh shape.

5. A method of manufacturing a compensator applied to a treatment using total body irradiation (TBI), the method comprising the steps of:
sensing a space depth of a body of a patient;
tracking and sensing a motion of the patient;
generating three-dimensional scan information on the body of the patient using the sensed space depth information and motion information; and
manufacturing the compensator using a 3D printer based on the three-dimensional scan information.

6. The method according to claim 5, wherein the three-dimensional scan information includes information on a length and a depth of a plurality of parts included in the body of the patient.

7. The method according to claim 5, wherein the compensator is manufactured to accomplish uniform distribution of radiation on the body of the patient based on dose distribution when the total body irradiation is performed.

8. The method according to claim 5, wherein the three-dimensional scan information is a three-dimensional data of a point cloud shape, and the method further includes the step of converting the three-dimensional data of the point cloud shape into a three-dimensional data of a mesh shape.
